(19) United States
(12) Patent Application Publication
(10) Pub. No.: US 2020/0127518 A1
(43) Pub. Date: Apr. 23, 2020

(54) STATOR

(71) Applicant: HONDA MOTOR CO., LTD., Tokyo (JP)

(72) Inventors: Keisuke Azusawa, Wako-shi (JP); Ryotaro Kaneko, Wako-shi (JP); Tadao Nishiyama, Wako-shi (JP)

(21) Appl. No.: 16/598,071

(22) Filed: Oct. 10, 2019

(30) Foreign Application Priority Data
Oct. 18, 2018 (JP) 2018-196993

(51) Int. Cl. H02K 3/30; H02K 3/38; H02K 3/52

(52) U.S. Cl. CPC H02K 3/30; H02K 3/525; H02K 3/38

(57) ABSTRACT

A stator includes an annular stator core, and a coil constituted by a plurality of electric wires and having a coil end protruding in an axial direction of the stator core, wherein the electric wire includes a conductor, and an insulating film that is configured to cover the conductor and that includes a porous having porous therein, and a non-porous film with no porous formed therein, and a non-porous film formed with no porous therein, a first coil end, which protrudes toward a first side in the axial direction as an end portion of the electric wire is disposed, is formed on the first side in the axial direction with respect to the stator core, and the porous film is provided on the first coil end.

### CROSS-REFERENCE TO RELATED APPLICATION

Priority is claimed on Japanese Patent Application No. 2018-196993, filed Oct. 18, 2018, the content of which is incorporated herein by reference.

### BACKGROUND OF THE INVENTION

### Field of the Invention

The present invention relates to a stator.

### Description of Related Art

In the related art, as a stator for a rotating electric machine, a configuration including a coil mounted on a stator core by inserting a conductor segment into slots formed in the stator core and joining conductor end portions protruding from the stator core is known. Regarding an electric wire used in such a coil, a plurality of fine porous are contained in an insulating film thereof, and various technologies for improving the insulation properties of an electric wire have been proposed.

For example, PCT International Publication No. 2017/073551 discloses a structure of an electric wire having a plurality of pores (porous) in an insulating film. The porous are formed by heating the insulating film including a pyrolytic resin and an outer shell member that surrounds the pyrolytic resin to a temperature at which the pyrolytic resin is gasified. When a porous having a capsule shape surrounded by an outer shell member is formed in this way, an insulating film having a low dielectric constant can be realized, and insulation properties of the electric wire with respect to a high voltage can be improved.

### SUMMARY OF THE INVENTION

However, in the technology disclosed in PCT International Publication No. 2017/073551, a bending strength of the insulating film is lower in comparison with an insulating film in which porous are not formed while the insulation properties are improved. For this reason, for example, when an electric wire is mounted on a stator to form a coil, damage such as cracks or the like may occur in the insulating film in a bent section of the electric wire. Accordingly, there is room for improvement in terms of providing a stator including an electric wire in which insulation properties of an insulating film at a place where insulation properties are required are improved and the flexibility of the insulating film is improved in a bent section of the electric wire.

An aspect of the present invention is directed to providing a stator including an electric wire in which insulation properties of an insulating film at a place where insulation properties are required are improved and flexibility of the insulating film is improved in a bent section of the electric wire.

(1) A stator according to an aspect of the present invention includes: an annular stator core; and a coil constituted by a plurality of electric wires and having a coil end protruding in an axial direction of the stator core, wherein the electric wire includes: a conductor; and an insulating film that is configured to cover the conductor and that includes a porous having porous therein, and a non-porous film with no porous formed therein, a first coil end, which protrudes toward a first side in the axial direction as an end portion of the electric wire is disposed, is formed on the first side in the axial direction with respect to the stator core, and the porous film is provided on the first coil end.

(2) In the aspect of the above-mentioned (1), a second coil end, which protrudes toward a second side in the axial direction as a bent section which is formed by bending the electric wire is disposed, is formed on the second side in the axial direction with respect to the stator core, and the non-porous film may be provided on the second coil end.

(3) In the aspect of the above-mentioned (1) or (2), the porous may be formed in a pyrolytic resin.

(4) In the aspect of any one of the above-mentioned (1) to (3), among the stator core, the porous film is provided in a region on the first side in the axial direction with respect to a central section of the coil.

According to the aspect of the above-mentioned (1), since the insulating film has the porous film, a dielectric constant of the insulating film can be decreased as the porous are formed, and insulation properties of the electric wire can be improved. Here, the end portion of the electric wire is disposed on the first coil end. The conductors of the electric wires are exposed at the end portions, and the electric wires of respective phases are bound when the conductors are coupled through welding or the like. Since the conductors are exposed at the end portions of the electric wires in this way and a distance between the electric wires is reduced by also coupling the end portions, excellent insulation properties are required. According to the stator of the present invention, since the porous film is disposed on the first coil end, insulation properties of the insulating film are able to be improved in portions in which it is not easy to secure a sufficient insulation distance.

Meanwhile, since the non-porous film has no porous therein, a strength of the insulating film can be improved in comparison with the porous film. Accordingly, damage to the insulating film due to occurrence or the like of cracks can be suppressed by disposing the non-porous film on the portion at which flexibility of the bent section or the like of the electric wire is required.

Accordingly, it is possible to provide a stator including an electric wire in which insulation properties of the insulating film at a place where the insulation properties are required are improved, and flexibility of the insulating film in the bent section of the electric wire is improved.

According to the aspect of the above-mentioned (2), since the non-porous film is disposed on the second coil end at which the bent section of the electric wire is located, strength of the insulating film in the bent section of the electric wire can be improved. In addition, since the state in which the bending strength is high can be maintained by disposing the non-porous film on the bent section, a porous density of the porous film disposed on the portion including the first coil end in which insulation is required can be increased.

Accordingly, it is possible to further improve insulation properties of the insulating film in the portion in which the insulation distance cannot be easily secured while improving strength of the insulating film in the bent section of the electric wire. Further, a space factor of the coil can be improved while costs can be reduced by thinning the insulating film to an extent in which the insulation properties are improved.

According to the aspect of the above-mentioned (3), since the porous is formed due to the pyrolytic resin, the porous film can be formed at a desired place on the insulating film by heating the desired place on the insulating film after manufacturing the electric wire. Specifically, the porous film can be disposed only on the portion corresponding to the first coil end in which the insulation properties are required by heating only the vicinity of the end portion of the electric wire. In this way, since the porous film can be disposed at a desired position through a simple method, workability can be improved.

According to the aspect of the above-mentioned (4), since the porous film is provided on the one side in the axial direction with respect to the central section of the coil of the stator core, the porous film can be reliably disposed on the first coil end at which the end portion of the electric wire in which the insulation distance cannot be easily secured is located. In addition, since the non-porous film is disposed on the other side in the axial direction with respect to the central section of the stator core, the non-porous film can be reliably disposed on the second coil end at which the bent section of the electric wire is located.

Accordingly, it is possible to provide the stator including the electric wire in which insulation properties of the insulating film at a place where the insulation properties are required are improved and flexibility of the insulating film in the bent section of the electric wire is improved.

### BRIEF DESCRIPTION OF THE DRAWINGS

FIG. 1 is a perspective view of appearance of a stator according to an embodiment.

FIG. 2 is a cross-sectional view taken along line II-II in FIG. 1.

FIG. 3 is a view showing a first coil end according to the embodiment, taken along an arrow III in FIG. 1.

FIG. 4 is a view showing a second coil end according to the embodiment, taken along an arrow IV in FIG. 1.

FIG. 5 is a cross-sectional view of an electric wire on which a porous film according to the embodiment is formed.

FIG. 6 is a cross-sectional view of the electric wire on which a non-porous film according to the embodiment is formed.

FIG. 7 is a view for describing a method of forming a porous according to the embodiment.

### DETAILED DESCRIPTION OF THE INVENTION

Hereinafter, an embodiment of the present invention will be described with reference to the accompanying drawings.

### (Stator)

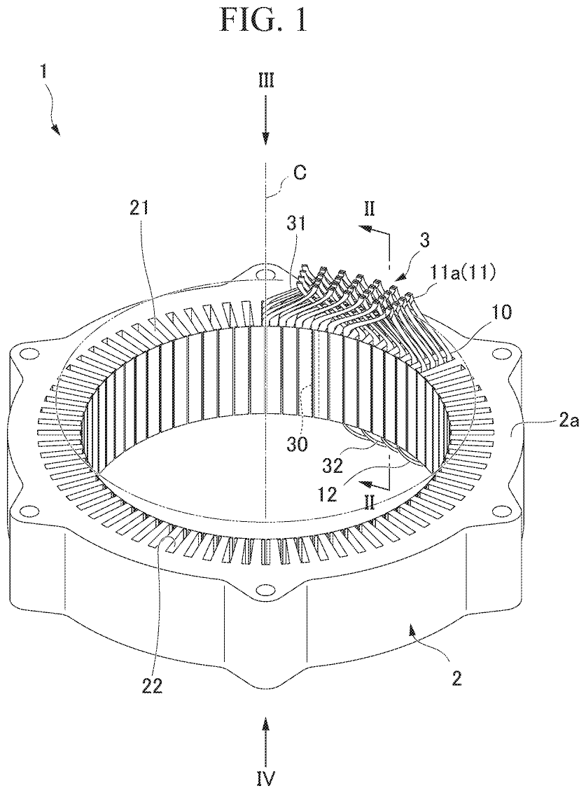

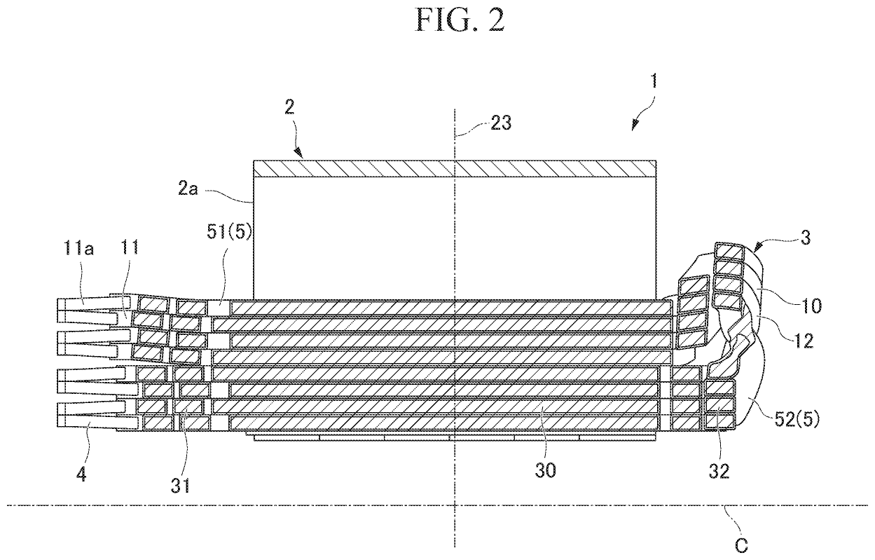

FIG. 1 is a perspective view of appearance of a stator 1. FIG. 2 is a partial cross-sectional view of the stator taken along line II-II in FIG. 1. An upper side in FIG. 1 corresponds to a left side in FIG. 2. The stator 1 includes a stator core 2 and a coil 3. Further, in FIG. 1, a part of the coil 3 is omitted for the convenience of description.

The stator core 2 is formed in an annular shape about an axis C. Teeth 21 are formed in an inner circumferential surface of the stator core 2. The teeth 21 protrude inward from the inner circumferential surface of the stator core 2 in the radial direction. A plurality of teeth 21 are provided in a circumferential direction.

Slots 22 are formed between the teeth 21, and the coil 3, which will be described below, is inserted into the slots 22. A rotor (not shown) is rotatably disposed about the axis C in the stator core 2.

In the following description, a direction along the axis C of the stator core 2 may be referred to as an axial direction, a direction perpendicular to the axis C may be referred to as a radial direction, and a direction around the axis C may be referred to as a circumferential direction.

The coil 3 is inserted into the slots 22 of the stator core 2 and mounted on the stator core 2. The coil 3 is constituted by a plurality of electric wires 10. Specifically, the coil 3 is inserted into the slots 22 from the other side in the axial direction (a side below in FIG. 1) in a state in which a plurality of electric wires 10 curved in a U shape are overlapped in the radial direction and the circumferential direction. After that, end portions 11 of the electric wires 10 protruding from the slots 22 toward one side in the axial direction (a side above in FIG. 1) are joined to each other, and the coil 3 is mounted on the stator core 2. A portion of the coil 3 inserted into the slots 22 is a coil insertion section 30. A portion of the coil 3 protruding from an end surface of the stator core 2 toward one side in the axial direction (a first side) is a first coil end 31. A portion of the coil 3 protruding from the end surface of the stator core 2 toward the other side in the axial direction (a second side) is a second coil end 32.

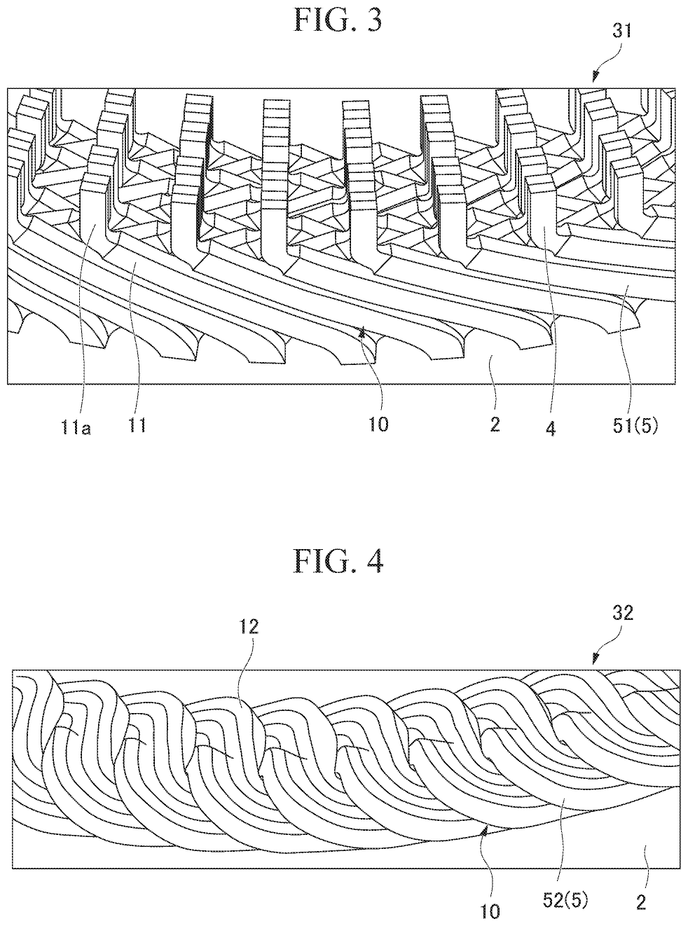

FIG. 3 is a view showing the first coil end 31, taken along an arrow III in FIG. 1.

The first coil end 31, which protrudes toward one side as the end portions 11 of the electric wires 10 are disposed, is formed on the one side in the axial direction with respect to the stator core 2. In other words, the first coil end 31 has the end portions 11 of the electric wires 10. The end portion 11 of the electric wire 10 has an exposed conductor section 11a in which a conductor 4 of the electric wire 10, which will be described below, is exposed. The exposed conductor section 11a is joined to the exposed conductor section 11a of another electric wire 10 arranged in the radial direction of the stator core 2 through welding or the like.

FIG. 4 is a view showing the second coil end 32 taken along an arrow IV in FIG. 1.

The second coil end 32, which protrudes toward the other side as a bent section 12 which is formed by bending the electric wire 10 is disposed, is formed on the other side in the axial direction with respect to the stator core 2.

In other words, the second coil end 32 has the bent section 12 of the electric wire 10. The bent section 12 is a portion obtained as the electric wire 10 is bent in a U shape, for example, when the electric wire 10 is mounted on the stator core 2. The electric wire 10 is fixed to the stator core 2 as the bent section 12 is further twisted and bent in the circumferential direction after the electric wire 10 is mounted on the stator core 2.

### (Electric Wire)

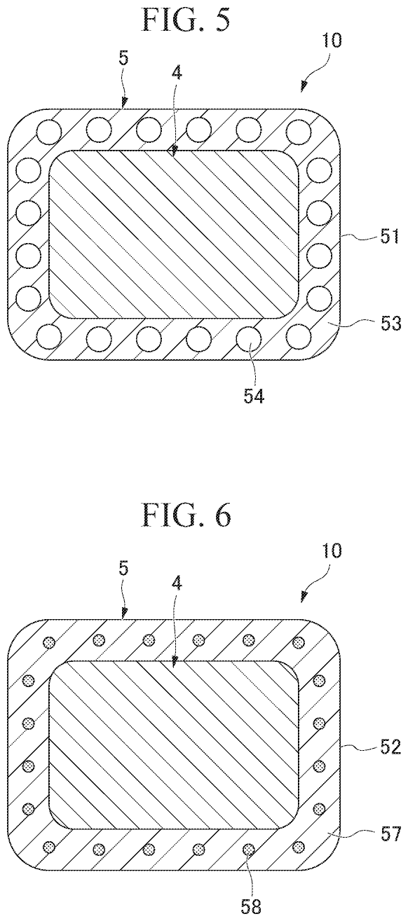

FIG. 5 is a cross-sectional view of the electric wire 10 disposed in the vicinity of the first coil end 31, and FIG. 6 is a cross-sectional view of the electric wire 10 in the vicinity of the second coil end 32. FIG. 5 and FIG. 6 show cross-sectional views taken at different portions in the single electric wire 10. The electric wire 10 includes the conductor 4 and an insulating film 5.

The conductor 4 constitutes a core portion of the coil 3, and is formed of, for example, a metal material such as copper or the like.

The conductor 4 is formed in a linear shape having a rectangular cross section. In the first coil end 31 disposed at one side in the axial direction of the stator core 2, at the exposed conductor section 11a (see FIG. 3) in which a part of the conductor 4 is exposed, neighboring exposed conductor sections 11a are electrically and physically joined to each other.

The insulating film 5 covers an outer circumferential section of the conductor 4. The insulating film 5 is formed of, for example, an insulating resin. The insulating film 5 is formed throughout the length of the conductor 4 except the exposed conductor section 11a. The insulating film 5 has a porous film 51 (see FIG. 5) having porous 54 therein, and a non-porous film 52 (see FIG. 6) with no porous 54 formed therein.

The porous film 51 is provided on one side in the axial direction in which the first coil end 31 is disposed.

Specifically, the porous film 51 in the embodiment is provided in a region on one side of the coil 3 with respect to a central section 23 (see FIG. 2) of the stator core 2 in the axial direction. The porous film 51 has an insulating member 53 in which the porous 54 are formed.

The insulating member 53 is formed of, for example, an insulating resin such as a polyimide or the like. A plurality of porous 54 are formed in the insulating member 53. In other words, the porous film 51 has a plurality of porous 54 therein. The porous 54 are formed in the insulating member 53 as a pyrolytic resin 58 (see FIG. 6) contained in the insulating member 53 is heated and the pyrolytic resin 58 is gasified.

The non-porous film 52 is provided on the other side in the axial direction in which the second coil end 32 is disposed. Specifically, the non-porous film 52 in the embodiment is provided in a region on the other side with respect to the central section 23 (see FIG. 2) of the coil 3 in the axial direction of the stator core 2. In other words, a boundary section between the porous film 51 and the non-porous film 52 is disposed in the vicinity of the central section 23 in the axial direction. The non-porous film 52 has the insulating member 53.

The insulating member 53 is formed of, for example, an insulating resin such as polyimide or the like. In the embodiment, the insulating member 53 of the porous film 51 and the insulating member 53 of the non-porous film 52 are formed of the same material. The pyrolytic resin 58 that is not gasified is contained in the insulating member 53 of the non-porous film 52.

The porous film 51 is provided on the first coil end 31. The non-porous film 52 is provided on the second coil end 32. Accordingly, the single electric wire 10 has a configuration including both of the porous film 51 and the non-porous film 52 according to a position with respect to the stator core 2.

### (Method of Forming Porous Film 51)

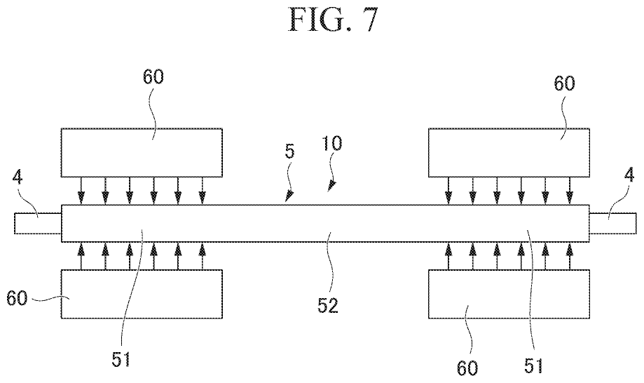

FIG. 7 is a view for describing a method of forming a porous film 51 (porous 54) in an electric wire 10.

The porous 54 are formed by gasifying the pyrolytic resin 58 contained in the insulating film 5 through heating the insulating film 5. Before the heating, the insulating film 5 is the non-porous film 52 including the pyrolytic resin 58 therein as a whole (a state in FIG. 6). Before the heating, heaters 60 are installed in regions of the electric wire 10 disposed on the side of the first coil end 31 when mounted on the stator core 2, i.e., only at the end portion 11 of the electric wire 10. In the region of the insulating film 5 heated by the heaters 60, the porous 54 are formed when the pyrolytic resin 58 disposed therein is gasified (a state in FIG. 5). Accordingly, the porous film 51 is formed on the end portion 11 of the electric wire 10. Further, the heater 60 is an apparatus for heating the insulating film 5 using, for example, a high frequency.

Meanwhile, the heaters 60 are not installed in a region of the electric wire 10 disposed on the side of the second coil end 32 when mounted on the stator core 2, i.e., an intermediate section of the electric wire 10. Accordingly, the pyrolytic resin 58 remains in the insulating film 5 while not being gasified. Accordingly, the non-porous film 52 is formed on the intermediate section of the electric wire 10.

### (Actions and Effects)

Next, actions and effects of the stator 1 will be described.

According to the stator 1 of the embodiment, since the insulating film 5 has the porous film 51, a dielectric constant of the insulating film 5 can be decreased when the porous 54 are formed, and insulation properties of the electric wire 10 can be improved.

Here, the end portions 11 of the electric wires 10 are disposed on the first coil end 31. In the electric wires 10, the electric wires 10 having the same phase are bound by exposing the conductors 4 in the end portions 11 and coupling the conductors 4 through welding or the like. Since the distance between the electric wires 10 is reduced by coupling the end portions 11 of the electric wires 10 to each other in the exposed conductor sections 11a in this way, high insulation properties are required. According to the stator 1 of the present invention, since the porous film 51 is disposed on the first coil end 31, the insulation properties of the insulating film 5 in the portion in which the insulation distance cannot be easily secured can be improved.

Meanwhile, since the non-porous film 52 has no porous 54 therein, strength of the insulating film 5 can be improved in comparison with the porous film 51. Accordingly, by arranging the non-porous film 52 in the section other than the portion in which the insulation distance cannot be easily secured, damage to the insulating film 5 can be suppressed in the portion in which flexibility of the bent section 12 or the like of the electric wire 10 is required.

Accordingly, it is possible to provide the stator 1 including the electric wire 10 in which insulation properties of the insulating film 5 at a place where the insulation properties are required are improved and flexibility of the insulating film 5 in the bent section 12 of the electric wire 10 is improved.

Since the non-porous film 52 is disposed on the second coil end 32 in which the bent section 12 of the electric wire 10 is located, strength of the insulating film 5 in the bent section 12 of the electric wire 10 can be improved. In addition, since the state in which the bending strength is high can be maintained by disposing the non-porous film 52 on the bent section 12, a porous density of the porous film 51 disposed on the portion including the first coil end 31 in which insulation is required can be increased. Accordingly, the insulation properties of the insulating film 5 on the portion in which an insulation distance cannot be easily secured can be improved while improving strength of the insulating film 5 in the bent section 12 of the electric wire 10. Further, a proportion of the coil 3 can be improved while reducing costs by thinning the insulating film 5 to an extent of improvement in the insulation properties.

Since the porous 54 is formed due to the pyrolytic resin 58, after the electric wire 10 is manufactured, the porous film 51 can be formed at a desired place of the insulating film 5 only by heating the desired place of the insulating film 5. Specifically, when the vicinity of the end portion 11 of the electric wire 10 only is heated, the porous film 51 can be disposed on only the portion corresponding to the first coil end 31 in which the insulation properties are required. In this way, since the porous film 51 can be disposed at the desired position through a simple method, workability can be improved.

Since the porous film 51 is provided at one side of the coil 3 with respect to the central section 23 of the stator core 2 in the axial direction, the porous film 51 can be securely disposed on the first coil end 31 at which the end portion 11 of the electric wire 10 in which the insulation distance cannot be easily secured is disposed. In addition, since the non-porous film 52 is disposed on the other side with respect to the central section 23 of the stator core 2 in the axial direction, the non-porous film 52 can be securely disposed on the second coil end 32 where the bent section 12 of the electric wire 10 is disposed.

Accordingly, it is possible to provide the stator 1 including the electric wire 10 in which insulation properties of the insulating film 5 at a place where the insulation properties are required are improved and flexibility of the insulating film 5 in the bent section 12 of the electric wire 10 is improved.

Further, the technical scope of the present invention is not limited to the above-mentioned embodiment, and various modifications may be made without departing from the scope of the present invention.

For example, in the above-mentioned embodiment, while the configuration in which a boundary section between the porous film 51 and the non-porous film 52 is disposed in the vicinity of the central section 23 has been described, there is no limitation thereto. In a state in which the electric wire 10 is mounted on the stator core 2, it is preferable to have the boundary section between the porous film 51 and the non-porous film 52 between the other side with respect to an end surface 2a (see FIG. 2) on one side of the stator core 2 in the axial direction and the one side with respect to the central section 23.

In addition, a cross-sectional shape of the conductor 4 and the insulating film 5 may be, for example, a round shape or the like.

A material of the insulating member 53 may be an insulating resin in addition to polyimide.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A stator comprising:
an annular stator core; and
a coil constituted by a plurality of electric wires and having a coil end protruding in an axial direction of the stator core,
wherein the electric wire comprises:
a conductor; and
an insulating film that is configured to cover the conductor and that includes a porous having porous therein, and a non-porous film with no porous formed therein,
a first coil end, which protrudes toward a first side in the axial direction as an end portion of the electric wire is disposed, is formed on the first side in the axial direction with respect to the stator core, and
the porous film is provided on the first coil end.

2. The stator according to claim 1, wherein a second coil end, which protrudes toward a second side in the axial direction as a bent section which is formed by bending the electric wire is disposed, is formed on the second side in the axial direction with respect to the stator core, and
the non-porous film is provided on the second coil end.

3. The stator according to claim 1, wherein the porous is formed in a pyrolytic resin.

4. The stator according to claim 2, wherein the porous is formed in a pyrolytic resin.

5. The stator according to claim 1, wherein, among the stator core, the porous film is provided in a region on the first side in the axial direction with respect to a central section of the coil.

6. The stator according to claim 2, wherein, among the stator core, the porous film is provided in a region on the first side in the axial direction with respect to a central section of the coil.

7. The stator according to claim 3, wherein, among the stator core, the porous film is provided in a region on the first side in the axial direction with respect to a central section of the coil.

8. The stator according to claim 4, wherein, among the stator core, the porous film is provided in a region on the first side in the axial direction with respect to a central section of the coil.
